(19) United States
(12) Patent Application Publication
(10) Pub. No.: US 2009/0060348 A1
(43) Pub. Date: Mar. 5, 2009

(54) Determination of Image Similarity

(76) Inventor: Donald Martin Monro, Beckington (GB)

Correspondence Address: UNGARETTI & HARRIS LLP;INTELLECTUAL PROPERTY GROUP - PATENTS, 70 WEST MADISON STREET, SUITE 3500, CHICAGO, IL, 60602-4224, US

(21) Appl. No.: 11/846,215

(22) Filed: Aug. 28, 2007

(51) Int. Cl. G06K 9/62

(52) U.S. Cl. 382/209

(57) ABSTRACT

A method and apparatus for measuring the similarity of images comprising determining a plurality of displacement vectors indicative of the relative positions of similar pixels (230) or groups of similar pixels between a pair of images, and processing displacement vectors so determined to derive one or more quantities indicative of a degree of similarity between said pair of images.

### CROSS-REFERENCE TO RELATED APPLICATIONS

N/A

### FEDERALLY SPONSORED RESEARCH OR DEVELOPMENT

N/A

### TECHNICAL FIELD

The present invention relates to a method and apparatus for measuring the similarity of images. In particular, although not exclusively, it may relate to biometric identification of an individual using an identifying image, for example of an iris, face, hand, ear or fingerprint. It may also may relate to the protection of image copyright by measuring the degree of similarity between images or portions if images. It may also relate to identifying a video sequence by similarities between images which may be representative of a sequence of video frames. It may also relate to identifying the location of images or portions of images for example by identifying two or more images as having the same or similar background even when taken from a different viewpoint.

### BACKGROUND OF THE INVENTION

In this application, the field of biometric identification, and more particularly human iris recognition is used as the primary illustrative example, although it is to be understood that the claimed subject matter is not limited in scope in this respect. A variety of biometrically-based techniques for the identification of individuals have been proposed, many of which rely on iris recognition. Existing patents and applications in this field include the following: U.S. Pat. No. 4,641,349, Flom & Safir; U.S. Pat. No. 5,572,596, Wildes et al; U.S. Pat. No. 5,751,836, Wildes et al; U.S. Pat. No. 5,901,238, Matsushita; U.S. Pat. No. 5,956,122, Doster; U.S. Pat. No. 6,229,906, Pu & Psaltis; U.S. Pat. No. 6,247,813, Kim & Ryoo; U.S. Pat. No. 6,526,160, Ito; U.S. Pat. No. 5,291,560, Daugman; WO-A-2005/11958, Monro.

### BRIEF DESCRIPTION OF THE DRAWINGS

Subject matter is particularly pointed out and distinctly claimed in the concluding portions of the specification. The claimed subject matter, however, both as to organization and the method of operation, together with objects, features and advantages thereof, may be best understood by a reference to the following detailed description when read with the accompanying drawings in which:

FIG. 1 is a flowchart illustrating an example embodiment of an image comparison scheme in accordance with the claimed subject matter;

FIG. 2 illustrates one embodiment of the determination of displacement vectors between two images;

FIG. 3 illustrates the extraction of a localised and normalised iris image from a photograph of a human eye;

FIG. 4 illustrates displacement vectors obtained with pairs of human iris images which are from the same and different eyes, together with histograms of the x- and y-components of the displacement vectors;

FIG. 5 illustrates the distribution of a similarity score calculated over a number of matching and non-matching human irises;

FIG. 6 illustrates the use of a first similarity score calculated from displacement vectors together with a second score obtained by a different method to measure the similarity of human irises; and

FIG. 7 is a block diagram of an exemplary embodiment of a computing platform

### DETAILED DESCRIPTION

In the following detailed description, numerous details are set forth in order to provide a thorough understanding of the present claimed subject matter. However, it will be understood by those skilled in the art that the claimed subject matter may be practiced without these specific details. In other instances, well-known methods, procedures, components, and circuits have not been described in detail so as to not obscure the claimed subject matter.

Various operations may be described as multiple discrete operations in turn, in a manner that may be helpful in understanding embodiments of the claimed subject matter; however, the order of description should not be construed to imply that these operations are order dependent.

According to the present invention there is provided a method of determining similarity between a first image and a second image, comprising:
(a) for each of a plurality of pixel groups in a first image, deriving a displacement vector indicative of the relative position in a second image of a corresponding pixel group, the corresponding pixel group being most similar to the first according to a selected similarity criterion; and
(b) deriving from the said vectors an image similarity measure indicative of the degree of similarity between said first and second images.

Here, each image may be an entire image in its own right, or it may form part of some larger image

The invention further extends to a computer program arranged to execute the method as previously defined. It further extends to a computer-readable medium holding any such computer program. It further extends to an apparatus and a system containing means for implementing the method as previously defined. It further extends to a data carrier holding instructions for implementing the method as previously defined.

In summary, the claimed method comprises firstly determining a plurality of displacement vectors for a pair of images which indicate the displacement of identical, substantially identical or similar regions of pixels between the two images; and secondly calculating from the displacement vectors so determined one or more quantities that can be used as an index, score, rating or measure indicative of the degree of similarity between the pair of images. For the purposes of this description such similarity quantities will be generally referred to as similarity measures or scores. Thirdly it may be determined by processing of said similarity measure whether the images are considered to be similar or not similar (i.e. the similarity measure may optionally be used for image-matching).

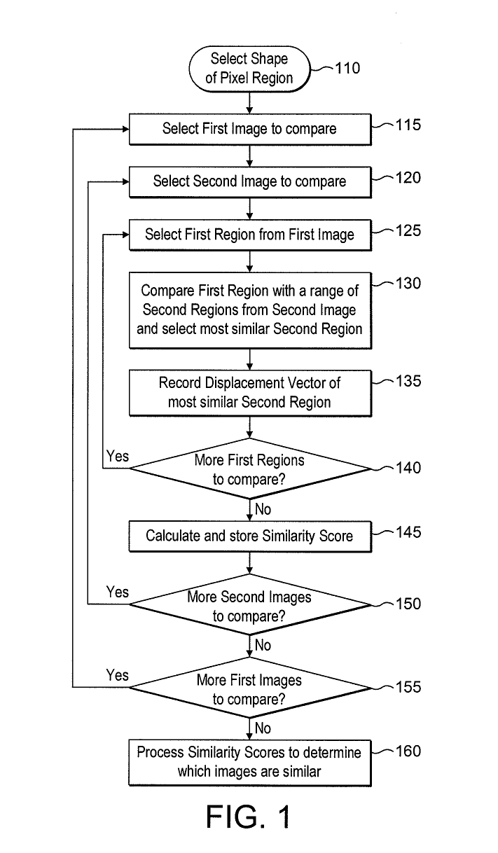

FIG. 1 is a schematic flowchart illustrating the operation of an exemplary embodiment in which a first image is to be compared with a second image, and the degree of similarity assessed. The images to be compared may be of any type including, for example, biometric images including images of irises, fingerprints, faces, ears, hands or any other image showing an identifying characteristic. The process to be described can equally well be applied to non-biometric images including photographs of a scene and even non-photographic computer generated images. The two images to be compared may come from the same or from different sources, and they may comprise individual images extracted from a video sequence. The overall task may simply be to compare first and second images, in which case the end result is typically some similarity score or some other similarity metric. Alternatively, the task may be to determine whether or not the first and second images “match”, that is to assess whether or not they are sufficiently similar according to some pre-defined criterion.

The second image may for example be an image from a database which is being searched for similarity with the first image. Such an application in the field of biometrics is known as “identification”, when a candidate first image is compared with many previously registered second images from a database. However the second image might instead be a single image of particular interest. In biometrics this task, which is much less time consuming than identification, is called “verification”, when the second image is one which is alleged to be similar and the task is to verify this similarity. In biometric identification, the task is typically to determine whether the first and second images do or do not come from the same individual. Of course, other match/non-match criteria may be used in other applications, for example in tracking the course of a disease by comparing “before” and “after” images.

Another example might be in attempting to determine if the background in one video sequence is similar to the background in another video sequence, in which both the first and second images might come from a selected range of images of interest. Such cases arise for example when terrorists or criminals send video sequences which may or may not have been recorded in the same or similar locations.

These are but examples of the way that images may be selected for comparison and claimed subject matter is not limited in scope in this respect.

Turning now to FIG. 1, at 110, the size and shape of a local pixel region is specified; this defines a notional “window” which will be moved across the pairs of images and within which the pixels will be compared.

Regions to be compared may be rectangular blocks, but in general the regions of pixels compared need not be rectangular. The block size may be selected according to the application; one-pixel blocks are not excluded. At 115 the first image is selected, and at 120 a second image is selected for comparison with said first image.

At 125 a first region is selected from said first image. At 130 the selected first region is processed together with a range of second regions from said second image, and one of said second regions is selected as being the most similar to said first region from said first image according to some condition. Said condition could, for example, be the minimum absolute difference between the regions processed, although it is known in the field that smoother displacement vectors can be obtained by other conditions as will be discussed below. Although the processing might be a straightforward comparison of pixels in the respective regions, it is known in the field that other forms of processing may produce displacement vectors, such as for example one of the processes known as optical flow, as will again be discussed below. There are but examples of processes that might be used to determine displacement vectors.

At 135 the displacement vector or vectors of the most similar regions are recorded in such a way that they may be selected for further processing. At 140 it is determined whether there are more regions of the first image to be compared to the second image, and if so processing returns to block 125.

At 145, when displacement vectors have been determined for all desired regions of the first image, one or more similarity scores indicative of the degree of similarity between the images are calculated and recorded for later processing. Some examples of these scores and the way in which they might be calculated are described below.

It is determined at 150 whether there are more second images to consider, and if so processing returns to block 120. It is determined at 155 whether there are more first images to consider, and if so processing returns to block 115.

At 160, when all required pairs of first and second images have been considered, the similarity scores determined for all pairs of images may be compared or otherwise processed to select one or more images considered to be most similar, or one or more images considered to be least similar. The quantities or ‘similarity scores’ calculated which are indicative of image similarity may, of course, be used in many different ways by themselves or in combination with other quantities determined by other methods.

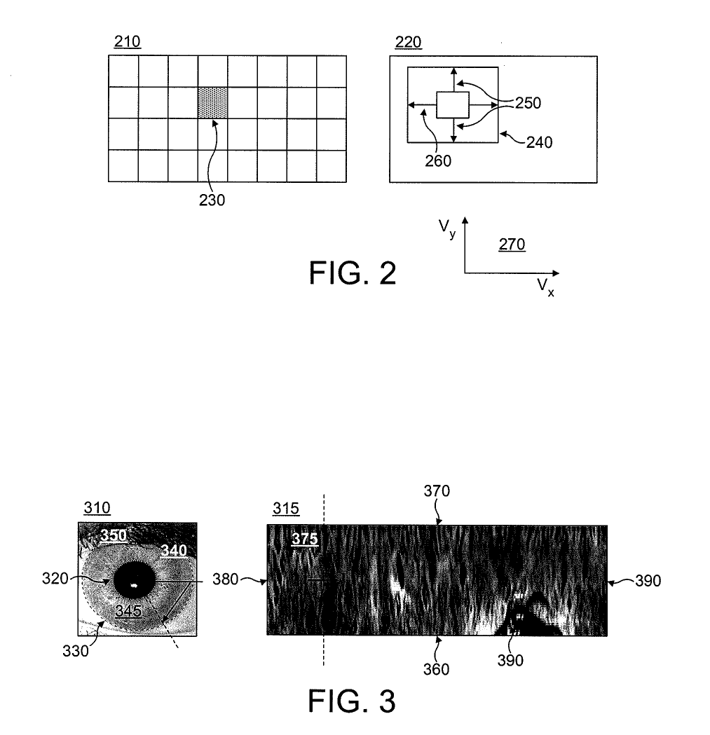

As a further illustration of this embodiment, FIG. 2 shows a first image 210 such as might have been selected at 115 and a second image 220 such as might have been selected at 120. The first image has been divided into regions which for the purpose of this example are rectangular blocks of pixels. A plurality of regions from the first image 210 is selected one at a time for comparison with the second 220. In one embodiment, as illustrated by FIG. 2, a range of regions 240 displaced vertically 250 and horizontally 260 around the corresponding position of the region 230. By applying some comparative function such as the sum of absolute differences between the pixels in the regions compared, the horizontal and vertical displacements of the region in the second image 220 which is most similar to the region 230 in the first image may be determined as a vector 270 which is stored for further processing as at 145.

One exemplary embodiment to be described below will be that of iris identification, although it will of course be understood that an identical approach may be used to identify specific or unique characteristics of any image, whether biometric or not.

The process of identification of an individual and/or uniquely characterising the iris starts by taking a photographic or other image of the eye, conventionally by infrared light. In this exemplary embodiment, the first image 210 and the second image 220 are photographs of a human eye taken at sufficient magnification to reveal detail of the iris sufficient for identification or verification. FIG. 3 shows at 310 one such image in which the pupil outline 320 and the iris outline 330 have been identified in order to extract the annulus which forms the iris and convert it to a new, unwrapped rectangular image of the iris, as shown at 315. To do this a vertical column of pixels at the leftmost end 380 of image 315 may be interpolated from a horizontal radius 340 of the image 210. As successive columns of pixels 385 are determined moving across the image 315 from left to right, these are interpolated from successive radii 345 rotating counter clockwise around the iris about a suitable centre usually within the pupil. As will be evident to one skilled in the art, it is convenient for a full traversal of the columns of the image from leftmost 380 to rightmost 390 to be interpolated from one full rotation of the radii through the iris.

In FIG. 3, the pupil outline becomes the top edge 370 of the image 315 and the iris outline becomes the bottom edge 360, as is evident from the incursion 395 of a portion of an eyelid 350 into the edge 360 of the image 315.

The pixels of the image 315 may be adjusted for brightness, background illumination and contrast. This process of localization and normalization of the iris into a rectangular image such as image 315 does not form part of the claimed novel subject matter of this invention, and can be carried out in many other ways. It is described herein in order to explain the application of the present invention for iris matching. It is however not essential to carry out this localization and normalization process in order to match human irises: on the contrary, the method could be applied directly to close up images of the human eye such as 310.

The image comparison in this application is carried out between a plurality of such iris images to determine which pairs, if any, exhibit sufficient similarity to be accepted as coming from the same eye, or alternatively to be added to a shortlist of those for further comparison.

If images or portions of images do not match, random vectors are obtained. On the other hand if images or portions of images represent a match, then substantially the same displacement vectors will usually be obtained. Corrupted by noise or containing several similar regions of patterns, vectors will typically still of course show some evidence of organized structure. This is true of all image comparisons and not is limited to the case of human iris matching.

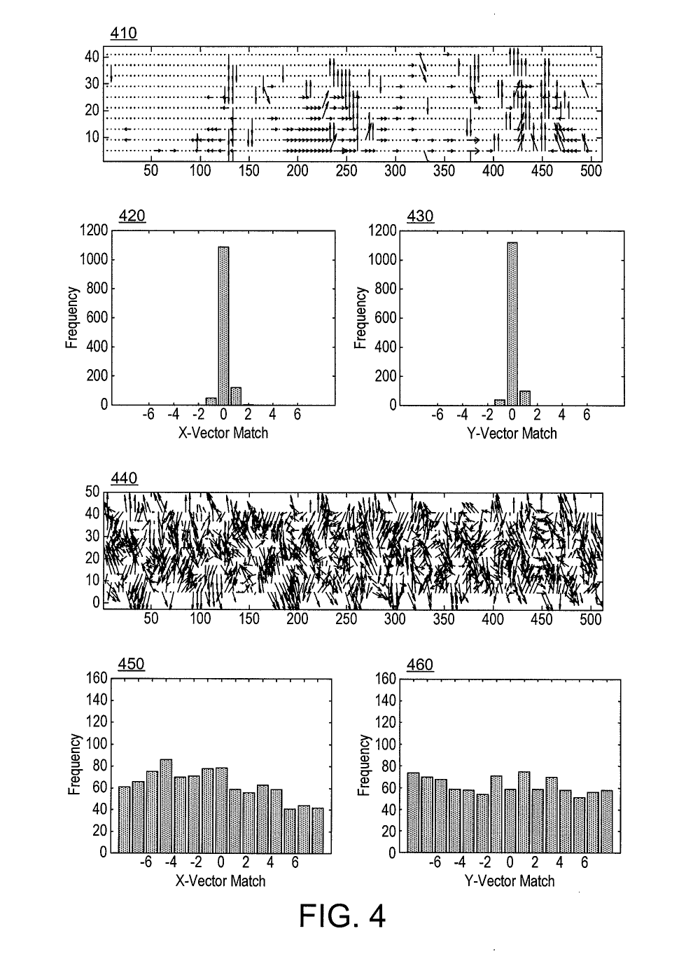

Continuing, however, with the exemplary embodiment applied to matching of localized and normalised iris images, once all first and second images have been processed as in FIG. 1, a list of vectors is obtained which may be processed to determine whether a pair of images are similar. In FIG. 4 at 410 a diagram, called a ‘quiver plot’ is shown to illustrate the distribution of vectors that are obtained at 135. Each small arrow in quiver plots at 410 and 440 has its root located in a first region of the first image and its tip located at the position in the second image where the most similar second region has been found by the process of FIG. 1. For images that are similar, the vectors are highly correlated as can be seen at 410 which is obtained from two different images of the same human iris. In the x-direction the displacement vectors are all very similar, as is particularly shown at 420 which is a histogram of the x-vectors of 410. The y-vectors are also very similar as is shown by the narrow distribution of the histogram 430 of the y-vectors from 410.

On the other hand, if the images are not similar a quiver plot such as 440 is obtained, which shows the typical displacement vectors from localized and normalized images of two different eyes. The disordered structure is evident, and the broader distribution of the values of the displacement vectors is also shown in the histogram 450 of x-vectors from 440 and the histogram 460 of y-vectors from 440. Clearly the displacement vectors 410 from similar eyes and those 440 from different eyes have greatly different statistics and are therefore good candidates for a biometric for identification or verification.

A particular strength of the claimed subject matter is evident from FIG. 4. It may occur that one image of the eye such as 310 is rotated relative to another image of the same eye. This happens naturally as a torsional rotation of the eye which is normally not very large, but may also happen due to positioning of the camera used, particularly if the camera is hand held. In the field of iris matching this is often compensated for by coding the iris of each registered eye in a database at several rotations, which is costly of storage and processing. It is also known as taught by Monro in U.S. application Ser. No. 11/363,500 (PCT/GB2007/000668) that a Fourier domain correlation method may be used to rotate the image either before or after normalization. However with the present claimed subject matter, these corrections are not necessary. Rotation of an iris image such as 310 would result in a shift to the right or left of the corresponding normalised image 315. When the displacement vectors are determined at 130, each vector would differs generally by the amount of this shift, although the difference in the searching region 240 may cause some degree of variation. In irises from the same eye, the same corresponding regions will nearly always be found, so that the x-vectors such as 410 are mainly offset by the same amount. In irises from different eyes, there may be more differences but the distribution of the x-vectors in 440, such as may be shown by the histogram 450, will still be spread out. In this way the method described naturally alleviates the problem of differing rotations of the image of the eye captured by the same or different cameras.

In order to quantify the similarity of two images, whether of the iris or in general, some calculation may be performed at 145 upon the displacement vectors recorded at 130 to produce a similarity measure such as a similarity score or other similarity metric. Depending upon the requirements of the application, this may either be a single value (a “score”), or may be some more complex multi-valued measure. Many types of calculation are possible, but the tight histogram 420 which is obtained typically with matching irises compared to the broad histogram 450 obtained typically with non-matching irises suggest two preferred calculations in particular.

One possible similarity score for images in general as well as the exemplary embodiment is the entropy of the x- or y-components of the displacement vectors, or some combination of both. Entropy is a metric which describes the degree of disorder of data, often used in data compression to estimate the cost of coding data, but equally useful as an indication of the disorder of data. If the probability of a particular value νₓ of an x-vector is p(νₓ), then the entropy over all possible x values is:

$$E ( {v}_{x} ) = {\sum }_{x} p ( {v}_{x} ) {log}_{2} p ( {v}_{x} )$$

Another possible metric is variance, or standard deviation—the square root of variance—which for x-vectors νₓ is calculated by summing the squared difference from the mean over all x-vectors νₓ^{k} as:

$$Var ( {v}_{x} ) = {\sum }_{k} {( {v}_{x}^{k} - μ ( {v}_{x} ) )}^{2}$$

Where μ(νₓ) is the is the mean value of the x-vectors νₓ.

If the distribution is disordered, as in the quiver plot 440 and the histograms 450, 460, the entropy will be larger than when the distribution is narrow, as in the quiver plot 410 and the histograms 420, 430. In fact the entropy of a completely disordered, flat histogram with N possible values should be log₂ N whereas if all the displacement vectors were the same as with a perfect match of all regions the entropy should be zero. In reality, two images of the same object may contain noise which may cause displacement vectors to differ, particularly in flat regions of the image where disorder may arise, and incursions of unexpected objects in what would otherwise be similar images may also have a disordering effect. In FIG. 3, the eyelid 350 which intrudes at 395 into the normalized human iris image 315, would have such an effect. This can, in practice, be mitigated in various ways including detecting the eyelid and/or eyelashes and not including them in the regions compared. Monro in U.S. application Ser. No. 11/363,500 (PCT/GB2007/000668) teaches that eyelashes may be removed, at least to some degree, by detecting their direction and filtering them.

Returning to the present example, it has been found that both the entropy of the x-vectors and the y-vectors is a good similarity score for separating matching and non-matching irises, as is the sum of x- and y-entropies.

In FIG. 4 it is evident that the displacement vectors have narrow histograms 420 and 430 for images of the same iris, and broad histograms 450 and 460 for non-matching irises. It has been found in practice that variance or standard deviation is also good for scoring similarity.

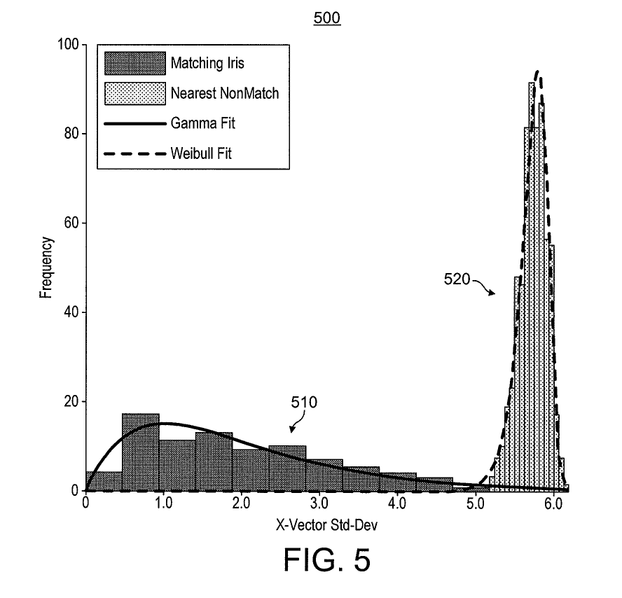

This is evident in FIG. 5, where the distribution of x-vector standard deviations is shown in graph 500. The non-matching distribution over a trial of several hundred eyes is given by the curve 520. As expected from the above discussion, this is narrow and clearly defined. The matching distribution is given by curve 510 which is more spread out because of the effects of noise, errors in localization, and incursion of eyelids and eyelashes. However despite these effects, the distributions are clearly separated, confirming that this particular similarity score is a strong biometric for iris matching.

With conventional iris recognition techniques, achieving a commercially acceptable false acceptance rate (where an individual is improperly identified as being known to the system) is in practice not too technically demanding. What is much more difficult, however, is achieving an acceptable false rejection rate (where a known individual is improperly rejected by the system). High false rejection rates in a commercial system are not conducive to easy consumer acceptance of the technology because of the anger and embarrassment that may easily be caused when a person who should be known to the system is incorrectly denied access.

The exemplary embodiment of claimed subject matter applied to human iris recognition has been shown experimentally to give good performance compared to existing classification methods. It is also ‘scalable’ meaning that its performance can be tuned over a range of False Acceptance Rates (FAR) and False Rejection Rates (FRR). This would be achieved, as in FIG. 5, by choosing a higher or lower threshold score to separate irises accepted as matching from those classified as non-matching. The classification method is capable of excellent False Acceptance Rates, i.e. effectively zero—which is comparable to fingerprint and DNA. In an identification task this means that the wrong person is (almost) never admitted. Arguably in identity verification this is unnecessary; one in 10,000 or less would be acceptable. The preferred embodiment of the present invention can provide false acceptance rates which are more than adequate for most if not all applications, while at the same time providing acceptable false rejection rates.

The claimed subject matter may be applied advantageously in conjunction with other image comparison methods or algorithms. Provided the scores used for classification are independent, or substantially independent, or at least partly independent, better recognition performance may be obtained than with either method alone.

An exemplary method that may be used in conjunction with the claimed subject matter is taught by Monro in U.S. Ser. No. 11/596,655, (WO-A-2005/119581), a particular embodiment of which is disclosed in detail by Monro et al in D. M. Monro, S. Rakshit, and D. Zhang, “DCT-based Iris Recognition,” IEEE Trans. PAMI, Vol. 29, No. 4, pp. 586-595, April 2007.

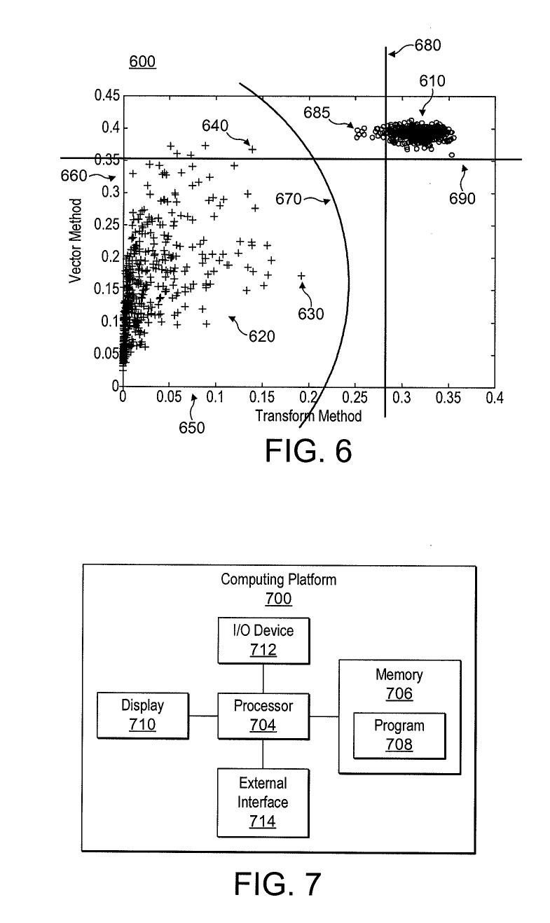

FIG. 6 shows a ‘scatter diagram’ 600 of the matching scores obtained using the results disclosed by Monro et al as the x-axis 650, plotted against the similarity scores obtained by a block matching embodiment of the claimed subject matter as the y-axis 660. Scores for images of the same eyes are shown as circles 610, and for different eyes are shown as crosses ‘+’ 620. As discussed, the non-matching scores cluster tightly, and in particular the clustering is tighter in the y-direction indicating that the claimed subject matter gives a narrower distribution for non matching eyes than the method of Monro et al. Both methods, however, are affected by the factors discussed above that cause matching distributions to be spread out. By combining the methods, however, the strengths of both can be conveniently exploited.

It is evident that for particular eyes where one method gives poor separation of the matching and non-matching eyes, such as at 630, 640, the other method may give good separation. The two methods exhibit a strong degree of independence and so can be used together to give better separation than either method alone. For example, the distributions 510, 520 of FIG. 5 are projections of these results on the y-axis 660 which may overlap near a score of 5.0. In FIG. 6, however, the matching points 620 and non-matching points 610 are widely separated and a suitably chosen line or curve 670 may separate the distributions more effectively and give lower FAR and FRR performance simultaneously.

The combination of methods in this manner is known in the field as multimodal classification, although it is known to some experts but not widely appreciated that two scores from the same basic biometric measurement, in this case an iris image, can beneficially be considered as a bimodal biometric.

In a practical embodiment of the claimed subject matter, pairs of images may be compared. The method of Monro et al, by comparison, can store the code of a particular eye and does not require both images of a pair to be processed together. It is no particular disadvantage in terms of memory to store images rather than codes because Rakhsit and Monro have demonstrated in ‘An analysis of image sampling and compression for human iris recognition’, IEEE Trans. Information Forensic and Security, September 2007, that images can be stored in compressed form without significant degradation in error rates when decompressed images are used for matching. Experiments show that this applies to the presently-claimed subject matter.

However the comparison of pairs of images that takes place in at least some of embodiments of the claimed subject matter may be slower and more costly of computational resources. Therefore, to take advantage of the relative strengths of the two methods when used in conjunction, it may be advantageous to apply to method of Monro et al as a ‘first cut’ using a threshold 680 that is high enough not to give false rejections at the expense of an increased chance of false acceptance 685 because the method of Monro et al may be less good at classifying non-matching irises 610 and may be better at classifying matching irises 620.

This may then be followed by an application of the claimed subject matter at a threshold 690 to irises that have been accepted to reject false acceptances 685 that may have been allowed through by the first stage. The original registered images would therefore only be required in a small minority of comparisons.

Claimed subject matter relies on the determination of regions of two images whose pixels are similar. This is a task that is well known in the field of image processing. In video compression, for example, many video compression schemes use so-called ‘motion compensation’ to predict regions of pixels in predicted frames from regions of pixels in reference frames. This method is widely used and will not be described here as it applies to video compression. However as a result of intense research and development activity in video compression, many methods of finding displacement vectors between pairs of images are known. The most accurate of these find the best match of pixels according to some criterion such as Sum of Absolute Differences (SAD) of pixels and carry out an exhaustive search to find the displacement vectors.

Other methods which are less accurate use a combination of prediction using the results from previous regions and simplified search patterns to find matches that may not be the best but are ‘close enough’. A characteristic of the less accurate methods is that they may find vectors for an image which have a smoother distribution, and as a consequence are less disordered. An example is the diamond search techniques which occurs in many variations, but see for example ‘New Results on Zonal Based Motion Estimation Algorithms—Advanced Predictive Diamond Zonal Search’, Alexis Michael Tourapis, Oscar C. Au and Ming L. Liou, Proceedings of IEEE International Conference of Electronics, Circuits and Systems (ICECS-1999), Cyprus, September 1999.

An example of a different search pattern may be found in ‘Unequal-arm adaptive rood pattern search for fast block-matching motion estimation in the JVT/H.26L’, Ma, K.-K.; Qiu, G, IEEE International Conference on Image Processing, ICIP 2003. In some cases a ‘rate criterion’ may be applied to reduce the entropy of the vectors. These methods can be extremely fast and hence mitigate the complexity disadvantage of the claimed subject matter.

Some recent reviews of motion estimation algorithms used in video compression can be found in K. R. Namuduri and J. Aiyuan, “Computation and performance trade-offs in motion estimation algorithms,” presented at Information Technology: Coding and Computing, 2001. Proceedings. International Conference on, 2001; and in M. Manikandan, P. Vijayakumar, and N. Ramadass, “Motion estimation method for video compression—An overview,” presented at Wireless and Optical Communications Networks, 2006 IFIP International Conference on, 2006.

Another class of methods which provides displacement vectors between pairs of images is the so-called optical flow approach, first described by Horn, B. K. P., and Schunck, B. G., ‘Determining Optical Flow’, Artificial Intelligence (17), No. 1-3, August 1981, pp. 185-203. In optical flow the underlying hypothesis is that any pixel in a first image moves to a new position in a second image in such a manner that pixels are flowing in an organized manner from one image to another. The analogy with fluid flow is exploited in methods of calculating optical flow using a diffusion model.

These methods have the reputation of being extremely costly of calculation resources because an iteration is normally employed. However approximate methods are also used, and a survey of optical flow methods can be found at J. L. Barron, D. J. Fleet, and S. S. Beauchemin, Performance of optical flow techniques, International Journal of Computer Vision, 12:1:43-77, 1994.

Although optical flow has not been used widely in video compression, there is at least a large degree of conceptual overlap between region matching and optical flow for the purposes of the claimed subject matter. A displacement vector of a region of pixels could be obtained by processing the vectors for every pixel produced by an optical flow calculation, for example by selecting particular vectors from the region or by processing the vectors in a region. Conversely region matching methods could be used with overlapping regions to produce vectors at every pixel.

For the purpose of claimed subject matter, any method may be employed that is capable of determining displacement vectors between a plurality of regions in pairs of images, including regions which are single pixels and displacement vectors which describe sub-pixel displacements.

Any method which gives smoother displacement vectors may mitigate the effects of noise and other factors that cause the matching distributions to be spread out, as at 510, 620 for normalized human iris images, but they would at the same time act to spread out the non-matching distributions such as 520, 610. Although some benefit may be derived from these fast, approximate, methods, they may have to be used with care in order not to obviate the beneficial effects on the matching distribution by adverse effects on the non-matching distributions. There are many opportunities for perfecting methods of determining displacement vectors for use with the claimed subject matter which is not limited in scope by any particular method or methods of determining displacement vectors either used singly or in combination.

Embodiments in accordance with claimed subject matter may be applied to measuring the similarity of images of all types. As is noted, some embodiments may perform well for human iris matching although claimed subject matter is not limited in scope thereby. It is intended that embodiments of claimed subject matter be applied to any one of a number of different types of image comparison. Therefore, claimed subject matter is not intended to be limited in terms of the type of image to which it may be applied.

It is noted, of course, that claimed subject matter is not limited to particular embodiments. Therefore, in addition to covering methods for determining the similarity of images, claimed subject matter is also intended to cover, for example, software incorporating such methods and to image comparators (whether implemented in hardware or software, or a combination of hardware and software).

The techniques described herein are not limited to any particular hardware or software configuration; they may find applicability in any computing or processing environment. The techniques may be implemented in hardware, software, firmware or a combination thereof. The techniques may be implemented in programs executing on programmable machines such as mobile or stationary computers, personal digital assistants, and similar devices that each include a processor, a storage medium readable or accessible by the processor (including volatile and non-volatile memory and/or storage elements), at least one input device, and one or more output devices. Program code is applied to the data entered using the input device to perform the functions described and to generate output information. The output information may be applied to one or more output devices.

Programs may be implemented in a high level procedural or object oriented programming language to communicate with a processing system. However, programs may be implemented in assembly or machine language, if desired. In any case, the language may be compiled or interpreted.

Programs may be stored on a storage medium or device, e.g. compact disk read only memory (CD-ROM), digital versatile disk (DVD), hard disk, firmware, non-volatile memory, magnetic disk or similar medium or device, that is readable by a general or special purpose programmable machine for configuring and operating the machine when the storage medium or device is read by the computer to perform the procedures described herein. The system may also be considered to be implemented as a machine-readable or accessible storage medium, configured with a program, where the storage medium so configured causes a machine to operate in a specific manner. Other embodiments are within the scope of the following claims.

Referring to FIG. 7, a block diagram of an exemplary computing platform 700 according to one or more embodiments is illustrated, although the scope of claimed subject matter is not limited in this respect. Computing platform 700 may include more and/or fewer components than those shown in FIG. 7. However, generally conventional components may not be shown, for example, a battery, a bus, and so on.

Computing platform 700, as shown in FIG. 7 may be utilized to embody tangibly a computer program and/or graphical user interface by providing hardware components on which the computer program and/or graphical user interface may be executed. Computing platform 700 may be utilized to embody tangibly all or a portion of embodiments described herein. Such a procedure, computer program and/or machine readable instructions may be stored tangibly on a computer and/or machine readable storage medium such as a compact disk (CD), digital versatile disk (DVD), flash memory device, hard disk drive (HDD), and so on. As shown in FIG. 5, computing platform 700 may be controlled by processor 704, including one or more auxiliary processors (not shown). Processor 704 may comprise a central processing unit such as a microprocessor or microcontroller for executing programs, performing data manipulations, and controlling the tasks of computing platform 700. Auxiliary processors may manage input/output, perform floating point mathematical operations, manage digital signals, perform fast execution of signal processing algorithms, operate as a back-end processor and/or a slave-type processor subordinate to processor 704, operate as an additional microprocessor and/or controller for dual and/or multiple processor systems, and/or operate as a coprocessor and/or additional processor. Such auxiliary processors may be discrete processors and/or may be arranged in the same package as processor 704, for example, in a multicore and/or multithreaded processor; however, the scope of the scope of claimed subject matter is not limited in these respects.

Communication with processor 704 may be implemented via a bus (not shown) for transferring information among the components of computing platform 700. A bus may include a data channel for facilitating information transfer between storage and other peripheral components of computing platform 700. A bus further may provide a set of signals utilized for communication with processor 704, including, for example, a data bus, an address bus, and/or a control bus. A bus may comprise any bus architecture according to promulgated standards, for example, industry standard architecture (ISA), extended industry standard architecture (EISA), micro channel architecture (MCA), Video Electronics Standards Association local bus (VLB), peripheral component interconnect (PCI) local bus, PCI express (PCIe), hyper transport (HT), standards promulgated by the Institute of Electrical and Electronics Engineers (IEEE) including IEEE 488 general-purpose interface bus (GPIB), IEEE 696/S-100, and so on, although the scope of the scope of claimed subject matter is not limited in this respect.

Other components of computing platform 700 may include, for example, memory 706, including one or more auxiliary memories (not shown). Memory 706 may provide storage of instructions and data for one or more programs 708 to be executed by processor 704, such as all or a portion of embodiments described herein, for example. Memory 706 may be, for example, semiconductor-based memory such as dynamic random access memory (DRAM) and/or static random access memory (SRAM), and/or the like. Other semi-conductor-based memory types may include, for example, synchronous dynamic random access memory (SDRAM), Rambus dynamic random access memory (RDRAM), ferroelectric random access memory (FRAM), and so on. Alternatively or additionally, memory 706 may be, for example, magnetic-based memory, such as a magnetic disc memory, a magnetic tape memory, and/or the like; an optical-based memory, such as a compact disc read write memory, and/or the like; a magneto-optical-based memory, such as a memory formed of ferromagnetic material read by a laser, and/or the like; a phase-change-based memory such as phase change memory (PRAM), and/or the like; a holographic-based memory such as rewritable holographic storage utilizing the photorefractive effect in crystals, and/or the like; and/or a molecular-based memory such as polymer-based memories, and/or the like. Auxiliary memories may be utilized to store instructions and/or data that are to be loaded into memory 706 before execution. Auxiliary memories may include semiconductor based memory such as read-only memory (ROM), programmable read-only memory (PROM), erasable programmable read-only memory (EPROM), electrically erasable read-only memory (EEPROM), and/or flash memory, and/or any block oriented memory similar to EEPROM. Auxiliary memories also may include any type of non-semiconductor-based memories, including, but not limited to, magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), and so on. Other varieties of memory devices are contemplated as well.

Computing platform 700 further may include a display 710. Display 710 may comprise a video display adapter having components, including, for example, video memory, a buffer, and/or a graphics engine. Such video memory may be, for example, video random access memory (VRAM), synchronous graphics random access memory (SGRAM), windows random access memory (WRAM), and/or the like. Display 710 may comprise a cathode ray-tube (CRT) type display such as a monitor and/or television, and/or may comprise an alternative type of display technology such as a projection type CRT type display, a liquid-crystal display (LCD) projector type display, an LCD type display, a light-emitting diode (LED) type display, a gas and/or plasma type display, an electroluminescent type display, a vacuum fluorescent type display, a cathodoluminescent and/or field emission type display, a plasma addressed liquid crystal (PALC) type display, a high gain emissive display (HGED) type display, and so forth, although the scope of the claimed subject matter is not limited in this respect.

Computing platform 700 further may include one or more I/O devices 712. I/O device 712 may comprise one or more I/O devices 712 such as a keyboard, mouse, trackball, touchpad, joystick, track stick, infrared transducers, printer, modem, RF modem, bar code reader, charge-coupled device (CCD) reader, scanner, compact disc (CD), compact disc read-only memory (CD-ROM), digital versatile disc (DVD), video capture device, TV tuner card, touch screen, stylus, electro-acoustic transducer, microphone, speaker, audio amplifier, and/or the like.

Computing platform 700 further may include an external interface 714. External interface 714 may comprise one or more controllers and/or adapters to prove interface functions between multiple I/O devices 712. For example, external interface 714 may comprise a serial port, parallel port, universal serial bus (USB) port, and IEEE 1394 serial bus port, infrared port, network adapter, printer adapter, radio-frequency (RF) communications adapter, universal asynchronous receiver-transmitter (UART) port, and/or the like, to interface between corresponding I/O devices 712. External interface 714 for an embodiment may comprise a network controller capable of providing an interface, directly or indirectly, to a network, such as, for example, the Internet.

In the preceding description, various aspects of claimed subject matter have been described. For purposes of explanation, systems and configurations were set forth to provide a thorough understanding of claimed subject matter. However, these are merely example illustrations of the above concepts wherein other illustrations may apply as well, and the scope of the claimed subject matter is not limited in these respects. It should be apparent to one skilled in the art having the benefit of this disclosure that claimed subject matter may be practiced without specific details. In other instances, well-known features were omitted and/or simplified so as to not obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

What is claimed is:

1. A method of determining similarity between a first image and a second image, comprising:
(a) for each of a plurality of pixel groups in a first image, deriving a displacement vector indicative of the relative position in a second image of a corresponding pixel group, the corresponding pixel group being most similar to the first according to a selected similarity criterion; and
(b) deriving from the said vectors an image similarity measure indicative of the degree of similarity between said first and second images.

2. The method of claim 1 wherein said displacement vectors are determined by block matching.

3. The method of claim 1 wherein said displacement vectors are determined by optical flow.

4. The method of claim 1 wherein at least one of said groups comprises a single pixel.

5. The method of claim 1 wherein at least one of said displacement vectors indicates sub-pixel displacement.

6. The method claim 1 wherein said deriving step includes forming one or more histograms derived from said vectors.

7. The method of claim 1 wherein said similarity measure is based on a statistic calculated from said displacement vectors or a portion of said displacement vectors.

8. The method of claim 7 wherein said statistic includes an entropy measure of said displacement vectors.

9. The method of claim 7 wherein said statistic includes a variance measure of said displacement vectors.

10. The method of claim 7 wherein said statistic includes an entropy measure and a variance measure, each derived from said displacement vectors.

11. The method of claim 1 including the further step of determining whether the first image matches the second image in dependence upon said similarity measure.

12. The method of claim 11 in which said further step comprises determining whether said first and second images match in dependence upon a resolved component of said displacement vectors.

13. The method of claim 1 including the further steps of:
(i) deriving using an image comparison algorithm a second independent image similarity measure; and
(ii) determining whether said first image matches said second image in dependence upon said similarity measure and said second independent similarity measure.

14. An apparatus for determining similarity between a first image and a second image, comprising:
(a) means, for each of a plurality of pixel groups in a first image, for deriving a displacement vector indicative of the relative position in a second image of a corresponding pixel group, the corresponding pixel group being most similar to the first according to a selected similarity criterion; and
(b) means for deriving from the said vectors an image similarity measure indicative of the degree of similarity between said first and second images.

15. The apparatus of claim 14 wherein said displacement vectors are determined by block matching.

16. The apparatus of claim 14 wherein said displacement vectors are determined by optical flow.

17. The apparatus of claim 14 wherein at least one of said groups comprises a single pixel.

18. The apparatus of claim 14 wherein at least one of said displacement vectors indicates sub-pixel displacement.

19. The apparatus of claim 14 wherein said deriving step includes forming one or more histograms derived from said vectors.

20. The apparatus of claim 14 wherein said similarity measure is based on a statistic calculated from said displacement vectors or a portion of said displacement vectors.

21. The apparatus of claim 20 wherein said statistic includes an entropy measure of said displacement vectors.

22. The apparatus of claim 20 wherein said statistic includes a variance measure of said displacement vectors.

23. The apparatus of claim 20 wherein said statistic includes an entropy measure and a variance measure, each derived from said displacement vectors.

24. The apparatus of claim 14 including means for determining whether the first image matches the second image in dependence upon said similarity measure.

25. The apparatus of claim 14 including:
(i) means for deriving using an image comparison algorithm a second independent image similarity measure; and
(ii) means for determining whether said first image matches said second image in dependence upon said similarity measure and said second independent similarity measure.

26. A computer program which, when executed, carries out the method of claim 1.

27. A computer readable medium carrying a computer program as claimed in claim 26.
